(19) United States
(12) Patent Application Publication
(10) Pub. No.: US 2024/0278447 A1
(43) Pub. Date: Aug. 22, 2024

(54) OBJECT CUTTING DEVICE FOR MANUFACTURE OF COMPOSITE MATERIALS

(71) Applicant: Industry-University Cooperation Foundation Sunmoon University, Asan-si (KR)

(72) Inventors: Min Soo KANG, Asan-si (KR); Jong Hwan YUN, Icheon-si (KR)

(73) Assignee: Industry-University Cooperation Foundation Sunmoon University, Asan-si (KR)

(21) Appl. No.: 18/176,147

(22) Filed: Feb. 28, 2023

(30) Foreign Application Priority Data
Feb. 21, 2023 (KR) 10-2023-0023067

(51) Int. Cl. B26D 7/14; B26D 7/08; B26D 7/26; B29B 15/08

(52) U.S. Cl. CPC B26D 7/14; B26D 7/086; B26D 7/2628; B29B 15/08; B26D 7/10

(57) ABSTRACT

The present disclosure provides an object cutting device for manufacturing a composite material including an arrangement unit configured to support an object at both sides, an upper cutting unit including an upper cutter configured to cut the object at an upper side, a lower cutting unit including a lower cutter configured to cut the object a lower side, and a collection unit configured to collect cut objects. According to embodiments of the present disclosure, it is possible to wind and unwind a connected object or positionally move an end thereof to prevent a reduction in a tensile force, thereby easily acquiring an object that is cut into more uniform lengths and enabling the mass production of the object.

### CROSS-REFERENCE TO RELATED APPLICATION

This application claims the benefit of Korean Patent Application No. 10-2023-0023067, filed on Feb. 21, 2023 in the Korean Intellectual Property Office, the disclosure of which is incorporated herein by reference.

### BACKGROUND

### 1. Field

The present disclosure relates to an object cutting device for manufacturing a composite material. Specifically, the present disclosure relates to a device suitable for mass production by uniformly and easily cutting an object provided as a reinforcer in the form of fiber.

### 2. Description of the Related Art

In various industrial fields, composite materials that reflect additives for improving physical performance and the like are used, and among them, composite materials with reinforcers formed in the form of fiber (continuum) are applied the most.

Since injection molding is difficult for the composite materials, such composite materials are manufactured and used through a device and method for cutting a plane- or line-shaped reinforcer, and to this end, a cutting device for the reinforcer is required.

However, the conventional cutting device has a problem that precise cutting is impossible because it is difficult to maintain a tensile force of a fibrous reinforcer, and an excessive working time is required when an operator cuts using a separate tool. In addition, a fiber strand-type reinforcer needs to be used with a length of 10 micrometers, which acts as a factor that makes mass production difficult.

### SUMMARY

Various embodiments of the present disclosure are directed to providing a device capable of cutting a reinforcer into uniform lengths.

In addition, the present disclosure is directed to maintaining and increasing a tensile force in a process of cutting a reinforcer, thereby preventing quality from being degraded.

In addition, the present disclosure is directed to easily cutting a conventional fibrous reinforcer to be suitable for mass production.

In addition, the present disclosure is directed to performing a cutting process while adjusting a distance in order to adjust an aspect ratio and easily collecting cut reinforcers.

The objects of the present disclosure are not limited to the above-described objects, and other objects that are not mentioned will be able to be clearly understood by those skilled in the art from the following description.

The present disclosure provides an object cutting device for manufacturing a composite material including an arrangement unit configured to support an object at both sides, an upper cutting unit including an upper cutter configured to cut the object at an upper side, a lower cutting unit including a lower cutter configured to cut the object at a lower side, and a collection unit configured to collect the cut objects.

The object cutting device may further include an arrangement position adjustment unit connected to the arrangement unit to adjust positions of the object in both side directions and a cutter position adjustment unit configured to adjust positions of the upper cutter and the lower cutter in both side directions.

The arrangement unit may include a first roller including a fixing groove into which one end of the object is inserted, and a second roller connected to the other end of the object.

The second roller may include an upper moving roller, and a lower moving roller connected to the upper moving roller, and the upper moving roller and the lower moving roller may be separated from each other and moved in a vertical direction.

The arrangement unit may further include a tensile force provider configured to move the upper moving roller or the lower moving roller in the vertical direction.

The first roller may rotate about a rotational axis to increase a tensile force of the object, and the object cutting device may further include a connection unit connecting and supporting one ends of the first roller and the second roller.

The connection unit may include a first connection portion connected to the one end of the first roller, and a second connection portion connected to the one end of the second roller, and as the first connection portion and the second connection portion are in contact with each other or spaced apart from each other, a distance between the first roller and the second roller may vary.

The object cutting device may further include a vibration forming unit connected to the first roller and the second roller to vibrate the object in a vertical direction.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a view showing the entirety of an object cutting device for manufacturing a composite material according to one embodiment of the present disclosure;

FIG. 2 is a view showing a configuration of the object cutting device for manufacturing a composite material according to one embodiment of the present disclosure;

FIG. 3 is a view showing an arrangement unit according to one embodiment of the present disclosure;

FIG. 4 is a view showing that a separation distance between a first roller and a second roller varies according to one embodiment of the present disclosure;

FIG. 5 is an enlarged view showing the first roller according to one embodiment of the present disclosure;

FIG. 6 is an enlarged view showing the second roller according to one embodiment of the present disclosure;

FIG. 7 is a view showing that positions of an upper moving roller and a lower moving roller vary according to one embodiment of the present disclosure;

FIG. 8 is a cross-sectional view of the object cutting device for manufacturing a composite material according to one embodiment of the present disclosure;

FIG. 9 is a view showing that the object is cut through the object cutting device for manufacturing a composite material according to one embodiment of the present disclosure;

FIG. 10 is a view showing a collection unit according to one embodiment of the present disclosure;

FIG. 11 is a view showing an arrangement unit according to another embodiment of the present disclosure;

FIG. 12 is a view showing a second roller according to another embodiment of the present disclosure; and

FIG. 13 is a view showing that the movement of an upper moving roller is restricted by a movement prevention groove according to another embodiment of the present disclosure.

### DETAILED DESCRIPTION OF EXEMPLARY EMBODIMENTS

Terms used herein are to describe the embodiments and are not intended to limit the present disclosure. In the specification, singular forms also include plural forms unless specifically stated otherwise in a phrase. Terms “comprises” and/or “comprising” used in the specification do not exclude the presence or addition of one or more other components other than the described components. The same reference numerals throughout the specification refer to the same components, and “and/or” includes each of the described components and any combination of one or more components. Although terms “first.” “second,” etc. are used to describe various components, it goes without saying that these components are not limited by these terms. These terms are only used to distinguish one component from another. Therefore, it goes without saying that a first component to be described below may also be a second element within the technical spirit of the present disclosure.

Unless otherwise defined, all terms (including technical and scientific terms) used in the specification may be used as the meanings commonly understood by those skilled in the art to which the present disclosure pertains. In addition, terms defined in commonly used dictionaries are not construed ideally or excessively unless explicitly specifically defined.

The spatially relative terms “below,” “beneath,” “lower,” “above.” “upper,” etc. may be used to easily describe a correlation between one component and other components as shown in the accompanying drawings. The spatially relative terms should be understood as terms including different directions of the components in use or at operation in addition to the directions shown in the drawings. For example, when a component shown in the drawing is flipped, a component described as being disposed “below” or “beneath” another component will be disposed “above” another component. Therefore, the exemplary term “below” may include both upward and downward directions. The components may also be directed in different directions, and thus the spatially relative terms may be construed according to the directions.

Before describing the present disclosure in detail, “object m” may be provided as a reinforcer to be cut and processed, but is not limited thereto. In addition, terms “central portion” of the object m refers to the central portion of the object m in which one end and the other end are formed.

In the present disclosure, when both ends of the object m are connected by a first roller 121 and a second roller 122, a position of one end or the other end of the object m in which a central portion is sagged is moved to induce the central portion of the object m to maintain a tight state and to be cut more easily and uniformly.

In addition, terms indicating directions, such as “upward” and “downward,” are expressed based on a form in which an object cutting device 10 for manufacturing a composite material according to the present disclosure is upright, and will be described based on the drawings unless otherwise specified.

In addition, terms indicating directions, such as “outside” and “inside”, refer to directions that move away from and approach with respect to a component having a rotational axis and a central axis, and the reference of the direction may be set to the above-described rotational axis or central axis.

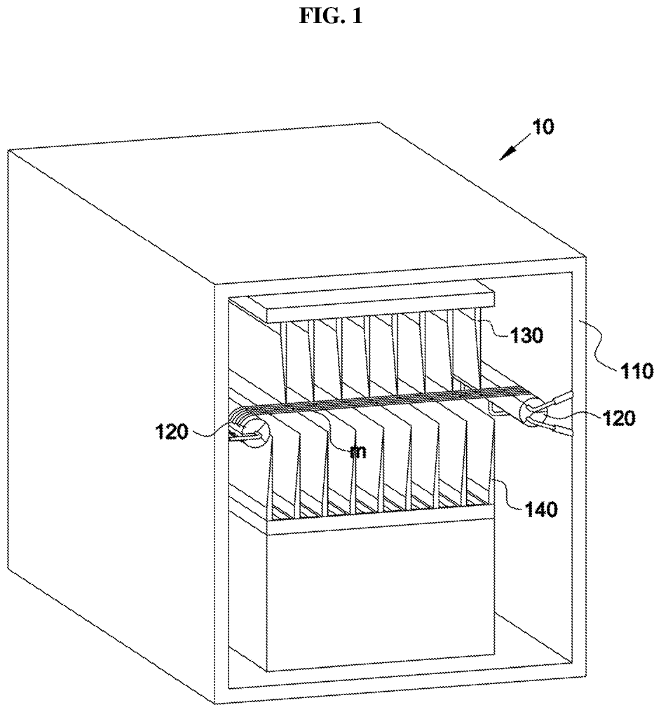

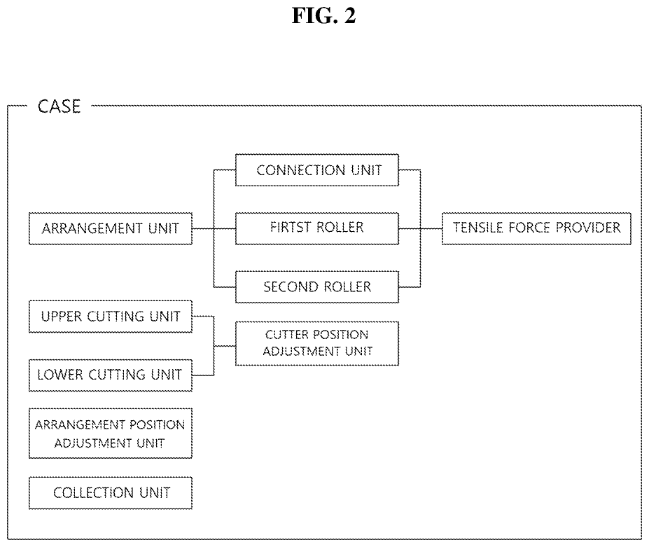

FIG. 1 is a view showing the entirety of an object cutting device 10 for manufacturing a composite material according to one embodiment of the present disclosure, and FIG. 2 is a view showing a configuration of the object cutting device for manufacturing a composite material according to one embodiment of the present disclosure.

The object cutting device 10 for manufacturing a composite material according to the present disclosure performs cutting by operating upward or downward with respect to an object m. To this end, the object cutting device 10 for manufacturing a composite material includes a case 110, an arrangement unit 120, an upper cutting unit 130, a lower cutting unit 140, and a collection unit 170.

The case 110 is a component for providing a working space for cutting the object m and has the arrangement unit 120, the upper cutting unit 130, and the lower cutting unit 140 disposed therein. By providing the case 110, it is possible to prevent scattering of foreign substances that may occur in a process of cutting the object m and guide the cut objects m to be easily moved to the collection unit 170.

The arrangement unit 120 is a component for supporting and guiding the object m to be cut and positioned inside the case 110. In the process of supporting the object m, the arrangement unit 120 increases and maintains a tensile force of the object m in contact with an upper cutting unit 130 and a lower cutting unit 140, thereby guiding the object m to be cut more uniformly and elaboratively. To this end, the arrangement unit 120 includes a first roller 121, a second roller 122, and a connection unit 123. In addition, the arrangement unit 120 may be connected to an arrangement position adjustment unit 150 positioned in the case 110 to move in a vertical direction and in both side directions.

The upper cutting unit 130 and the lower cutting unit 140 are components for cutting the object m and approaching the object m in a state of being positioned upward and downward from the object m. In this process, a pressure is applied to the object m in the vertical direction, and the object m may be easily cut.

The upper cutting unit 130 and the lower cutting unit 140 include an upper cutter 131 and a lower cutter 141, respectively, and a cutter position adjustment unit 160 may adjust the positions of the upper cutter 131 and the lower cutter 141. In addition, a separate heating element is formed on the upper cutter 131 and the lower cutter 141 to apply heat to the object in a high-temperature environment and at the same time, cut the object, and thus it is possible to easily cut the object without applying higher external force to the object.

For example, the heating element formed on the blade-shaped upper cutter 131 and the lower cutter 141 may be provided in the form of a coil or hot wire, but is not limited thereto.

The cutter position adjustment unit 160 is a component for adjusting the positions and number of installations of the upper cutting unit 130 and the lower cutting unit 140 and moving the upper cutter 131 and the lower cutter 141 in both side directions and in the vertical direction in a state of being respectively connected to the upper cutting unit 130 and the lower cutting unit 140.

The cutter position adjustment unit 160 may be provided as a moving device to which a rail and a lifter capable of moving the upper cutter and the lower cutter 141 in a direction parallel to the ground or moving the upper cutter and the lower cutter 141 in the vertical direction are coupled, but is not limited thereto.

For example, the cutter position adjustment unit 160 may be formed in the case and may be provided as a pair of cutter position adjustment units 160 to be connected to the upper cutting unit 130 and the lower cutting unit 140.

After the plurality of upper cutters and lower cutters 141 formed in the blade shape are connected to the cutter position adjustment unit 160 in an inserted or fastened form, the upper cutter and the lower cutter 141 are positionally moved in response to the movement of a first position moving portion 1223a and a second position moving portion 1223b, which will be described below.

The cutter position adjustment unit 160 may selectively move one or more upper cutters and lower cutters 141 among the plurality of upper cutters and lower cutters 141 in the vertical direction and change arrangement angles of all of the upper cutters and the lower cutters 141 in the form of “/” or “\”.

In addition, the cutter position adjustment unit 160 may adjust distances between the plurality of upper cutters or distances between the lower cutters 141 and change a size of the object m to be cut by the upper cutter or the lower cutter 141.

Therefore, the approach and cutting of the upper cutter and the lower cutter 141 that actively correspond to the arrangement position and arrangement state of the object m may be automatically performed. Therefore, it is possible to minimize an operator's intervention in the process of processing the object m and automatically induce the uniform processing of the object m, thereby easily producing good products.

In addition, according to the operator's request, the upper cutters 131 and the lower cutters 141 are added or removed as much as the desired number to adjust the distance therebetween, and when angles thereof are adjusted to adjust the tension force of the object, arrangement angles of the upper cutter 131 and the lower cutter 141 may be adjusted.

The collection unit 170 is a component for collecting the object m that is cut through the upper cutting unit 130 and the lower cutting unit 140 and positioned downward from the lower cutting unit 140. Cut objects m move downward by gravity and are collected by the collection unit 170 while moving.

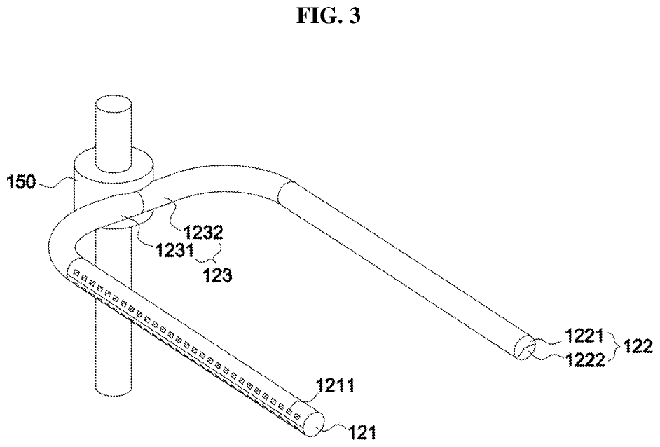

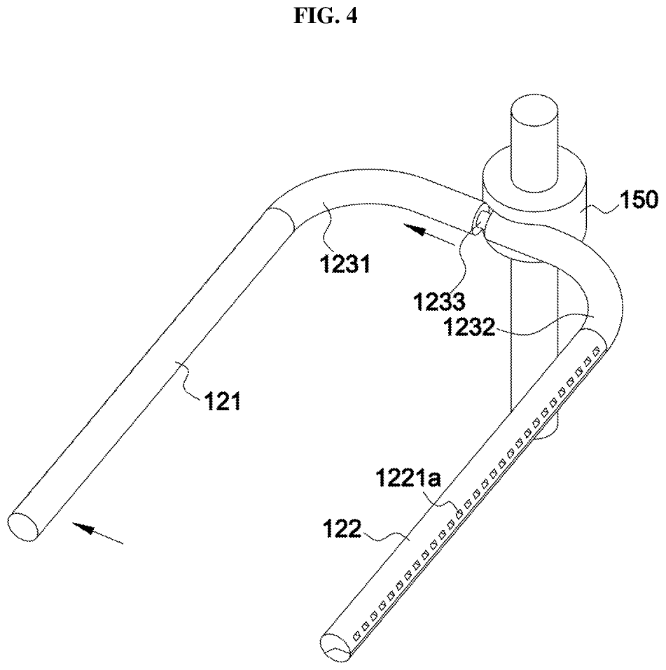

FIG. 3 is a view showing the arrangement unit 120 according to one embodiment of the present disclosure, and FIG. 4 is a view showing that a separation distance between the first roller 121 and the second roller 122 varies according to one embodiment of the present disclosure.

As described above, the arrangement unit 120 guides the object m to be cut in a fixed state. To this end, the arrangement unit 120 includes the first roller 121 and the second roller 122 for supporting the object m in both side directions and the connection unit 123 connecting the first roller 121 and the second roller 122. In addition, a position of the arrangement unit 120 may be changed as the arrangement unit 120 is connected to the arrangement position adjustment unit 150, and in this process, as the separation distance between the first roller 121 and the second roller 122 is changed, the tensile force of the object m may be changed.

The first roller 121 fixes one end of the object m. Specifically, the first roller 121 maintains a state of being connected to one end of the object m and rotates about a rotational axis, as necessary, to adjust the tensile force of the object m. To this end, the first roller 121 is provided in the form of a rod and has one or more connection grooves 1211, into which one end of the object m may be inserted and fixed, formed in the outer surface thereof. The plurality of connection grooves 1211 may be formed in a longitudinal direction of the first roller 121 or provided to have an arc or circular arrangement along the rotational axis.

The second roller 122 is spaced apart from the first roller 121 and connected to the other end of the object m. Specifically, the second roller 122 is provided to prevent a position of the other end of the object m from unintentionally moving in the vertical direction and increase and maintain the tensile force of the object m identically to the first roller 121. To this end, the second roller 122 is provided in the form of a rod and has one end connected to the connection unit 123 identically to the first roller 121.

In addition, the second roller 122 is divided into an upper moving roller 1221 and a lower moving roller 1222, and one or more upper fixing grooves 1221a and lower fixing grooves 1222a are formed on an outer surface of each the upper moving roller 1221 and the lower moving roller 1222.

The upper moving roller 1221 moves along the outer surface of the lower moving roller 1222 or the lower moving roller 1222 moves along the outer surface of the upper moving roller 1221, and thus a position of the other end of the object m may be moved to adjust the tensile force of the object m.

The connection unit 123 is a component for supporting the first roller 121 and the second roller 122 and adjusting the distance between the first roller 121 and the second roller 122, as necessary. To this end, the connection unit 123 may be bent or curved so that both ends are provided in a form connected to one end of the first roller 121 and one end of the second roller 122 and may be moved in the vertical direction in the state of being connected to the arrangement position adjustment unit 150 to be described below.

In addition, the connection unit 123 is divided into a first connection portion 1231 connected to the first roller 121 and a second connection portion 1232 connected to the second roller 122. The first connection portion 1231 and the second connection portion 1232 may be in contact with each other or separated from each other, and in response thereto, the distance between the first roller 121 and the second roller 122 may vary. To this end, an stretchable moving portion 1233 capable of moving the positions of the first connection portion 1231 and the second connection portion 1232 in both side directions (referring to a bottom-left direction and a top-right direction in FIG. 3) using electricity or hydraulic pressure may be installed on the first connection portion 1231 or the second connection portion 1232.

A separate rotational device capable of rotating the connected first roller 121 about the rotational axis may be installed on the first connection portion 1231. Therefore, the first roller 121 may be axially rotated based on the rotational device to wind and unwind the object m having one end inserted into and connected to the connection groove 1211. Therefore, it is possible to easily adjust the tensile force of the object m.

The arrangement position adjustment unit 150 is a component for adjusting the positions of the object m and the arrangement unit 120. Specifically, the arrangement position adjustment unit 150 is a component for to moving the position of the arrangement unit 120 connected to the object m in the vertical direction and may be formed as an assembly of an upright member in a vertical form capable of moving up and down and an insertion member connected to the arrangement unit 120. Here, the first connection portion 1231 and the second connection portion 1232 may be moved in both side directions by the stretchable moving portion 1233 in a state of being inserted into the insertion member.

FIG. 4 is an example showing that the separation distance from the second roller 122 increases as the first roller 121 moves in one direction (top-left direction in FIG. 4). Referring to FIG. 4, the first roller 121 and the first connection portion 1231 connected to the first roller 121 are integrally moved in one direction by the stretchable moving portion 1233. Therefore, the first roller 121 and the second roller 122 move away from each other, and the tensile force of the object m having one end and the other end respectively connected to the first roller 121 and the second roller 122 increases. Therefore, it is possible to prevent the central portion of the object m from being unintentionally sagged downward.

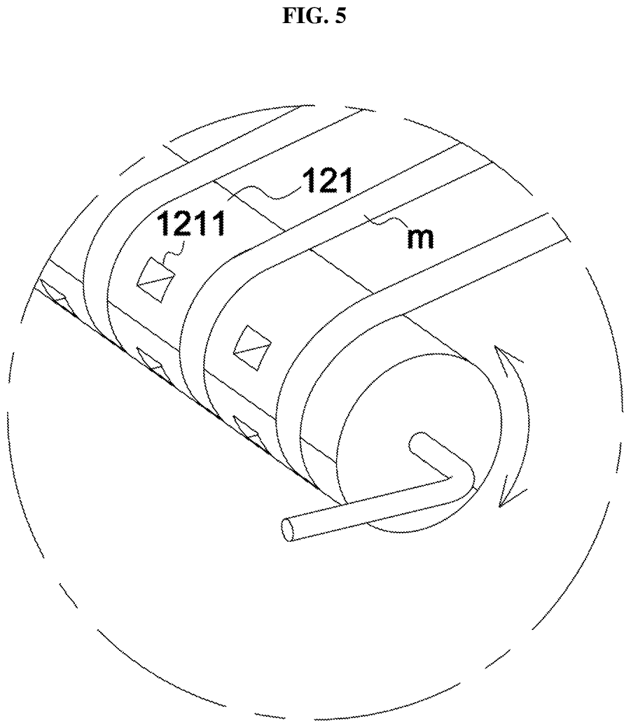

FIG. 5 is an enlarged view showing the first roller 121 according to one embodiment of the present disclosure.

The one end of the object m may be fixed to the first roller 121 in which the connection groove 1211 is formed, and the first roller 121 may be rotated about the rotational axis by the rotational device. In response thereto, the tensile force of the object m may vary.

For example, when the object m is wound through a rotational motion of the first roller 121, one end of the object m is wound as much as a circumferential distance according to the rotational motion of the first roller 121 in a state of being connected to the first roller 121. Therefore, the tensile force increases as the central portion of the object m moves toward the first roller 121. Therefore, it is possible to more easily cut the upper cutter and the lower cutter 141 approaching the object m.

In addition, the first roller 121 may move to approach or to be spaced apart from the second roller 122 by the stretchable moving portion 1233 or wound and unwound by the rotational device, thereby more easily maintaining the tensile force of the object m. In addition, one end of the object m may move as much as a relatively large circumferential distance through the stretchable moving portion 1233 and then finely move through the rotational device so that the tension force of the object m may be adjusted in two ways.

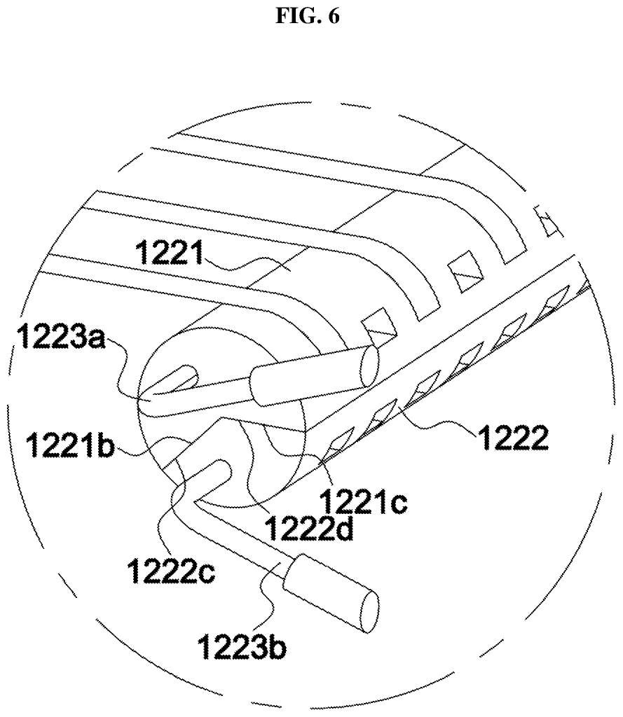

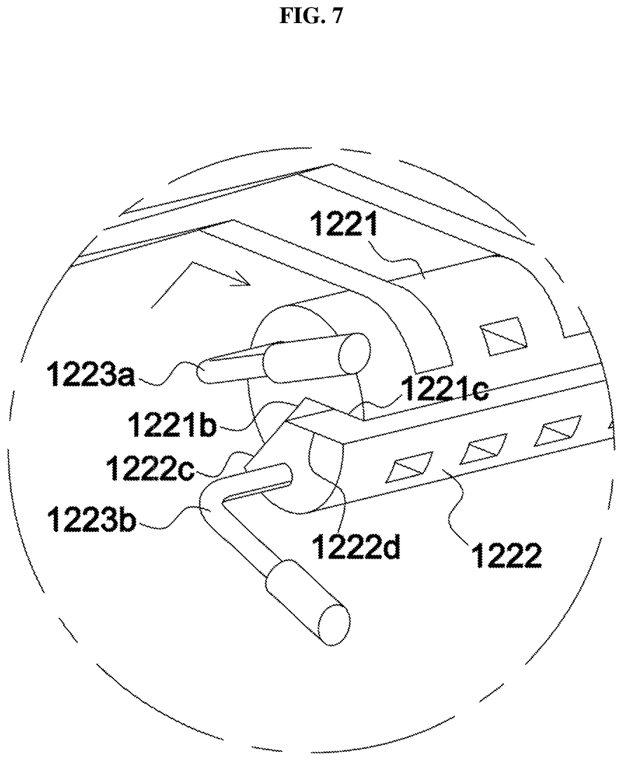

FIG. 6 is an enlarged view showing the second roller 122 according to one embodiment of the present disclosure, and FIG. 7 is a view showing that positions of the upper moving roller 1221 and the lower moving roller 1222 vary according to one embodiment of the present disclosure.

As described above, the second roller 122 may be divided into the upper moving roller 1221 and the lower moving roller 1222, and as the positions of the upper moving roller 1221 and the lower moving roller 1222 separately move, the position of the other end of the object m may be changed so that the tensile force of the object m may vary.

The upper moving roller 1221 is a component for positionally moving the object m positioned above the first roller 121 and the second roller 122. Specifically, the upper moving roller 1221 positionally moves the other end of the object m disposed upward from the second roller 122 to secure the tensile force and at the same time, allows the other end of the object m to be positioned above one end of the object m.

To this end, the upper moving roller 1221 is positioned upward from the lower moving roller 1222 to be described below, and the object m is positioned upward and is provided in the form of a rod having one end and the other end. Specifically, the upper moving roller 1221 is formed in the form of a bar having a predetermined first circular arc cross section. In addition, the upper moving roller 1221 includes a first inclined surface formed to have a predetermined first inclined angle with respect to the ground and a first flat surface parallel to the ground.

One or more upper fixing grooves 1221a having the same purpose as the connection groove 1211 formed in the first roller 121 may be formed in the outer surface of the upper moving roller 1221, and the other end of the object m may be inserted into the upper fixing grooves 1221a. When a plurality of upper fixing grooves 1221a are provided, the upper fixing grooves 1221a may be disposed in the longitudinal direction of the upper moving roller 1221.

The first inclined surface corresponds to a second inclined surface formed on the lower moving roller 1222 to be described below, and the first flat surface corresponds to a second flat surface provided on the lower moving roller 1222. Therefore, the upper moving roller 1221 having the first inclined surface may move in a diagonal direction along the second inclined surface, then may be parallel to the ground along the second flat surface, and may move in one direction (right direction in FIG. 6) that moves away from the first roller 121.

The lower moving roller 1222 is a component for positionally moving the object m positioned downward from the first roller 121 and the second roller 122 and moving the object m so that the other end is positioned under the one end.

To this end, the lower moving roller 1222 is positioned downward from the upper moving roller 1221 and includes the lower fixing groove 1222a formed identically to the upper fixing groove 1221a in the outer surface thereof. In addition, the lower moving roller 1222 is provided in the form of a bar having a second arc cross section to correspond to the upper moving roller 1221.

In addition, the lower moving roller 1222 includes the second inclined surface and the second flat surface respectively corresponding to the first inclined surface and the first flat surface formed on the upper moving roller 1221, and the second inclined surface is formed to have a predetermined second inclined angle.

For example, when the first inclined surface and the second inclined surface, and the first flat surface and the second flat surface formed on the upper moving roller 1221 and the lower moving roller 1222 are disposed in contact with each other, the second roller 122 in which the upper moving roller 1221 and the lower moving roller 1222 are combined has a circular cross-sectional shape.

A tension force provider 1223 is a component for adjusting the tension force of the object m by changing the position of the second roller 122. Specifically, the tension force provider 1223 changes the position of the other end of the object m connected to the second roller 122, thereby preventing the tension force of the object m from being reduced. In addition, the tension force provider 1223 tilts the object m by changing the position of the one end of the object m rather than the other end, thereby inducing uniform contact and cutting between the upper cutting unit 130 and the lower cutting unit 140 and the object m.

The tension force provider 1223 is connected to the upper moving roller 1221 and the lower moving roller 1222 in a state of being connected to the case 110 and moves the upper moving roller 1221 or the lower moving roller 1222 in the vertical direction. To this end, the tension force provider 1223 includes the first position moving portion 1223a and the second position moving portion 1223b.

The first position moving portion 1223a is a component for positionally moving the upper moving roller 1221, formed in the case 110, and has an end connected to the upper moving roller 1221. Here, a position at which the end of the first position moving portion 1223a is connected may be an end or an outer surface of the upper moving roller 1221, but is not limited thereto.

The first position moving portion 1223a is formed in a multi-stage shape that may extend in a state of being fixed to an inner side of the case 110, and thus may positionally move the upper moving roller 1221 connected to the end thereof.

The end of the first position moving portion 1223a may be connected to an end of the upper moving roller 1221 and provided to face a diagonal downward direction. In other words, when the upper moving roller 1221 moves integrally as the end of the first position moving portion 1223a shrinks and moves, the upper moving roller 1221 may move away from the first roller 121 and at the same time, the first inclined surface may move upward along the second inclined surface of the lower moving roller 1222.

The second position moving portion 1223b is provided for the same purpose as the first position moving portion 1223a and positionally moves the lower moving roller 1222. To this end, the second position moving portion 1223b is formed in the case 110 and has an end connected to an end or an outer surface of the lower moving roller 1222.

Like the first position moving portion 1223a, the second position moving portion 1223b may be provided in a multi-stage form in which the position of the end may vary depending on the stretchable movement. In addition, the second position moving portion 1223b is provided to have the end facing diagonally upward and is connected to the lower moving roller 1222. Therefore, the lower moving roller 1222 connected to the second position moving portion 1223b may have the second inclined surface and the second flat surface separated from the first inclined surface and the first flat surface of the upper moving roller 1221 to positionally move downward and easily adjust the tension force of the object m positioned under the lower moving roller 1222.

By providing the second position moving portion 1223b, the second inclined surface of the lower moving roller 1222 may move along the first inclined surface of the upper moving roller 1221 with respect to the object m having an excessively large tensile force, thereby reducing the separation distance between the first roller 121 and the second roller 122. Therefore, it is possible to reduce the tensile force of the object m, thereby preventing damage to the object m and guiding the object m to be cut more uniformly and easily.

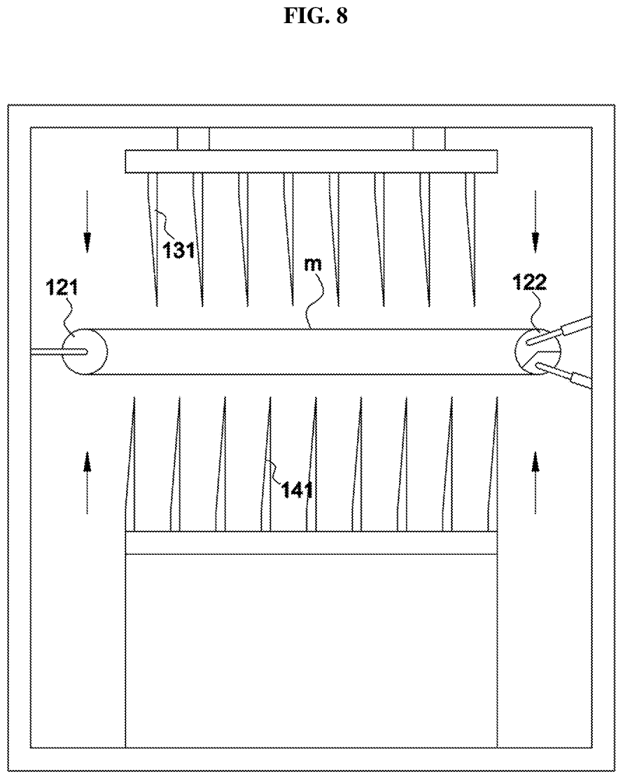

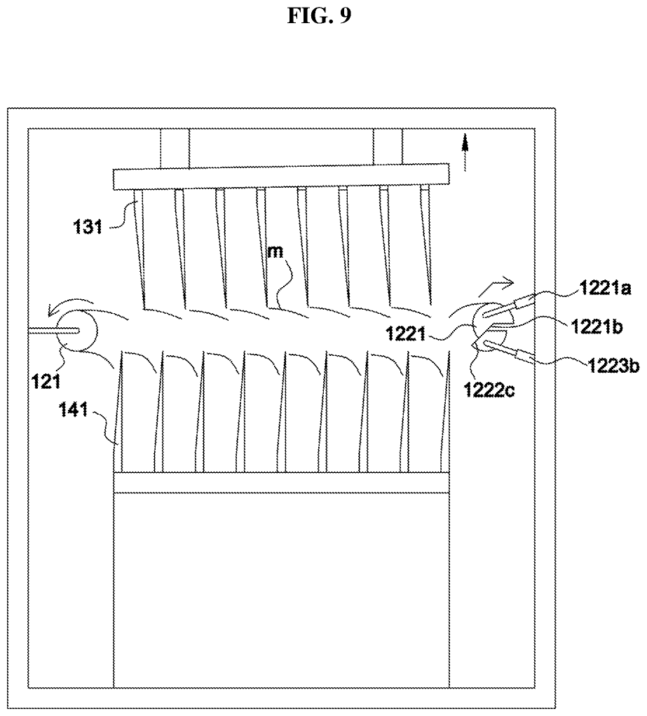

FIG. 8 is a cross-sectional view of the object cutting device 10 for manufacturing a composite material according to one embodiment of the present disclosure, and FIG. 9 is a view showing that the object m is cut through the object cutting device 10 for manufacturing a composite material according to one embodiment of the present disclosure.

Referring to FIG. 8, the object m whose position in the vertical direction is fixed by the first roller 121 and the second roller 122 is positioned between the upper cutting unit 130 and the lower cutting unit 140. The upper cutting unit 130 and the lower cutting unit 140 move toward and approach the object m in the vertical direction, and the upper cutter and the lower cutter 141 pressurize the contacted object m to perform cutting.

FIG. 9 shows that the object m positionally moved by the upper moving roller 1221 and the lower moving roller 1222 is cut, and the other end of the object m connected to the upper moving roller 1221 moves up compared to the one end thereof in response to the upper moving roller 1221 moving along the second inclined surface. Therefore, the object m has a form that is not parallel to the ground and obliquely disposed. At the same time, as the other end of the object m is positionally moved to move away from the one end of the object m connected to the first roller 121, it is possible to maintain a state in which the tensile force of the object m is not reduced.

Therefore, the upper cutter and the lower cutter 141 may act on the object m whose position is changed to have a “/” form in a state of being parallel to the ground, thereby more easily cutting the object m.

As another embodiment of the present disclosure, the object cutting device 10 for manufacturing a composite material may further include a controller for adjusting angles of the upper cutting unit 130 and the lower cutting unit 140.

The controller is provided to increase cutting precision by increasing areas of the upper cutting unit 130 and the lower cutting unit 140 in contact with the object m. To this end, the controller is connected to the first position moving portion 1223a and the second position moving portion 1223b for moving the upper moving roller 1221 and the lower moving roller 1222, respectively, and simultaneously connected to the cutter position adjustment unit 160.

The controller measures the positions of the first position moving portion 1223a and the second position moving portion 1223b every predetermined time (e.g., 1 second) and adjusts the positions of the upper cutting unit 130 and the lower cutting unit 140 in response to the positional movement of the first position moving portion 1223a and the second position moving portion 1223b in the measurement process.

Specifically, the controller acquires position information of the first position moving portion 1223a and the second position moving portion 1223b in the form of three-dimensional coordinates every predetermined time and moves the upper cutter and the lower cutter 141 in the vertical direction or in both side directions (left-right direction in FIG. 9) in response to a change in the position information. Here, the movement of the upper cutter and the lower cutter 141 in the vertical direction is performed through the cutter position adjustment unit 160, and as described above, the movement in the vertical direction and the movement in both side directions may be individually performed.

For example, when the position of the first position moving portion 1223a is moved 10 cm, 0 cm, and 10 cm in a state in which the positions of the first roller 121 and the second position moving portion 1223b are fixed, the object m has the position of the other end connected to the second roller 122 that moves upward in a state in which the one end connected to the first roller 121 is fixed and moves to move away from the first roller 121.

The controller acquires the positional movement of the other end of the object m according to the positional movement of the first position moving portion 1223a as the changed positional information and controls the cutter position adjustment unit 160 based on the acquired positional information. Specifically, the controller moves one or more upper cutters and lower cutters 141 close to the second roller 122 up to correspond to the acquired positional information. Therefore, distances of all of the upper cutters or lower cutters 141 approaching the object m are the same. Therefore, it is possible to apply a uniform force to the object m and easily guide the cutting of the object m to have uniform size and good quality.

Through a series of the above-described processes, by adjusting the distances between the plurality of upper cutters or the distances between the plurality of lower cutters 141, it is possible to cut the object m to a desired size. In addition, regarding the movement of the first position moving portion 1223a and the second position moving portion 1223b for maintaining or increasing the tensile force of the object m, it is possible to change the positions and angles of the upper cutting unit 130 and the lower cutting unit 140 to correspond to the positionally moved object m, thereby more accurately and easily cutting the object m.

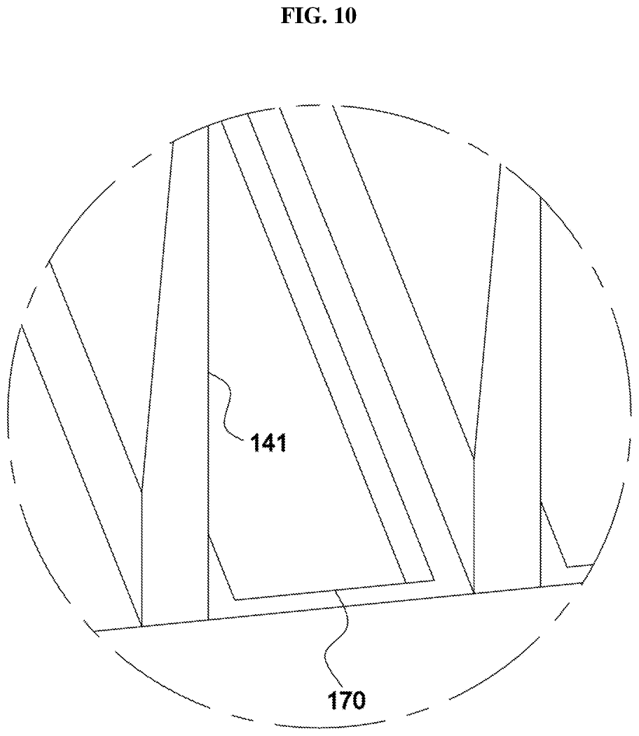

FIG. 10 is a view showing the collection unit 170 according to one embodiment of the present disclosure.

The collection unit 170 is a component for collecting the cut objects m. To this end, the collection unit 170 is connected to the lower cutting unit 140. Specifically, the collection unit 170 is positioned downward from the lower cutting unit 140 and provided in the form of a tray that may be drawn in and out from the case 110. The objects m that are cut through the upper cutting unit 130 and the lower cutting unit 140 is moved downward by gravity and are disposed and collected on the collection unit 170. Therefore, it is possible to minimize the loss of manpower related to the collection of the cut object m.

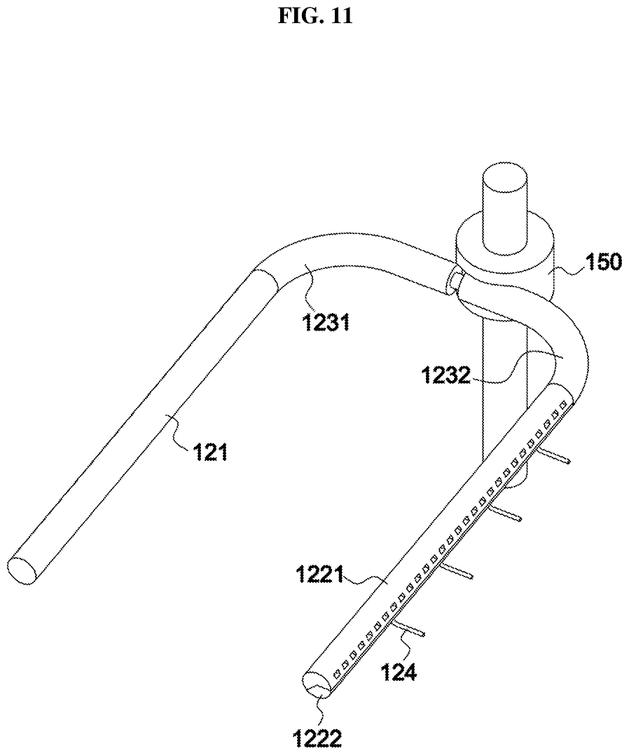

FIG. 11 is a view showing the arrangement unit 120 according to another embodiment of the present disclosure.

The object cutting device 10 for manufacturing a composite material according to the present disclosure further includes a vibration forming unit 124 connected to the first roller 121 or the second roller 122 to vibrate the object m.

The vibration forming unit 124 is a component for inducing the object m to be more easily cut by applying vibration to the object m. To this end, the vibration forming unit 124 is formed in the case 110, connected to the first roller 121 or the second roller 122, and has a separate vibration terminal embedded therein. Here, the vibration forming unit 124 may be selectively connected to the first roller 121 or the second roller 122 or connected to both of the first roller 121 and the second roller 122. For example, the vibration forming unit 124 may be connected to an outer surface of a lower moving roller 1222 facing downward to transmit vibrations to the lower moving roller 1222.

By providing the vibration forming unit 124, as vibrations are applied to the object m disposed to have a relatively smaller tensile force and thus moving tension in the vertical direction is given to the object m, the object m may additionally approach the upper cutting unit 130 and the lower cutting unit 140, thereby more easily inducing the cutting.

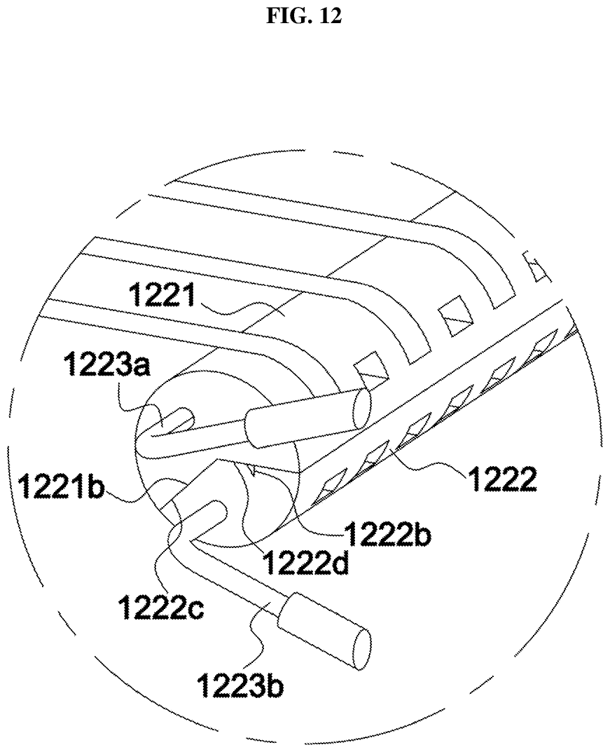

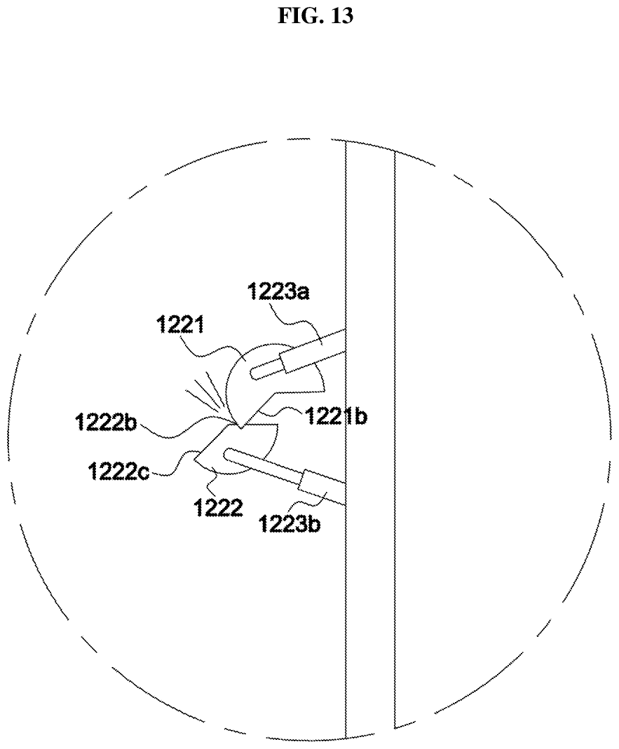

FIG. 12 is a view showing the second roller 122 according to another embodiment of the present disclosure, and FIG. 13 is a view showing that the movement of the upper moving roller 1221 is restricted by a movement prevention groove 1222b according to another embodiment of the present disclosure.

The second roller 122 according to another embodiment of the present disclosure may further include the movement prevention groove 1222b for restricting the movement of the upper moving roller 1221.

The movement prevention groove 1222b is formed in the lower moving roller 1222 in contact with the upper moving roller 1221. Specifically, the movement prevention groove 1222b is engraved from the second flat surface provided on the lower moving roller 1222 and provided in the longitudinal direction of the lower moving roller 1222. Here, a single movement prevention groove 1222b may be provided or a plurality of movement prevention grooves 1222b may also be provided to be spaced predetermined intervals from each other.

Referring to FIG. 13, the upper moving roller 1221 moving along the second inclined surface by the first position moving portion 1223a has an end inserted into the movement prevention groove 1222b on the second flat surface thereof. Therefore, the additional movement of the upper moving roller 1221 is restricted.

By providing the movement prevention groove 1222b, it is possible to limit the excessive movement of the upper moving roller 1221, thereby preventing the object m connected to the upper moving roller 1221 from being unintentionally broken. Meanwhile, the movement prevention groove 1222b may be formed in the second inclined surface to restrict the movement of the upper moving roller 1221 to a smaller moving distance compared to a case of being formed in the second flat surface.

According to embodiments of the present disclosure, it is possible to wind and unwind a connected object or positionally move an end thereof to prevent a reduction in a tensile force, thereby easily acquiring an object that is cut into more uniform lengths and enabling the mass production of the object.

The effects of the present disclosure are not limited to the above-described effect, and other effects that are not mentioned will be able to be clearly understood by those skilled in the art from the above detailed description.

Although embodiments of the present disclosure have been described with reference to the accompanying drawings, those skilled in the art to which the present disclosure pertains will be able to understand that the present disclosure may be carried out in other specific forms even without changing the technical spirit or essential features of the present disclosure. Therefore, it should be understood that the above-described embodiments are illustrative and not restrictive in all respects.

What is claimed is:

1. An object cutting device for manufacturing a composite material, comprising:
an arrangement unit configured to support an object;
an upper cutting unit including an upper cutter configured to cut the object at an upper side; and
a lower cutting unit including a lower cutter configured to cut the object at a lower side.

2. The object cutting device of claim 1, further comprising an arrangement position adjustment unit connected to the arrangement unit to adjust positions of the object and the arrangement unit.

3. The object cutting device of claim 1, further comprising a cutter position adjustment unit configured to adjust positions of the upper cutter and the lower cutter.

4. The object cutting device of claim 1, wherein the arrangement unit includes:
a first roller including a fixing groove into which one end of the object is inserted; and
a second roller connected to the other end of the object.

5. The object cutting device of claim 4, wherein the second roller includes:
an upper moving roller; and
a lower moving roller connected to the upper moving roller,
wherein the upper moving roller and the lower moving roller are separated from each other and moved in a vertical direction.

6. The object cutting device of claim 5, wherein the arrangement unit further includes a tensile force provider configured to move the upper moving roller or the lower moving roller in the vertical direction.

7. The object cutting device of claim 4, wherein the first roller rotates about a rotational axis to increase a tensile force of the object.

8. The object cutting device of claim 4, further comprising a connection unit connecting and supporting one ends of the first roller and the second roller.

9. The object cutting device of claim 8, wherein the connection unit further includes:
a first connection portion connected to the one end of the first roller; and
a second connection portion connected to the one end of the second roller,
wherein, as the first connection portion and the second connection portion are in contact with each other or spaced apart from each other, a distance between the first roller and the second roller varies.

10. The object cutting device of claim 4, further comprising a vibration forming unit connected to the first roller or the second roller to vibrate the object in a vertical direction.
